(19) United States
(12) Patent Application Publication
(10) Pub. No.: US 2008/0271354 A1
(43) Pub. Date: Nov. 6, 2008

(54) Method and apparatus for distortion free imaging on mirrored surface

(76) Inventor: Grant Phillips Bostrom, La Jolla, CA (US)

Correspondence Address: DONN K. HARMS;PATENT & TRADEMARK LAW CENTER, SUITE 100, 12702 VIA CORTINA, DEL MAR, CA, 92014, US

(21) Appl. No.: 12/151,385

(22) Filed: May 5, 2008

Related U.S. Application Data
(60) Provisional application No. 60/916,286, filed on May 5, 2007.

(51) Int. Cl. G09F 19/16; B32B 37/14; B32B 38/14

(52) U.S. Cl. 40/615; 156/106; 156/313; 156/277

(57) ABSTRACT

A device and method for formation of indicia adjacent to a mirrored surface yielding substantially distortion free reflections of said indicia in said mirrored surface. Mirrors so formed can be employed as background for photographs and graphics and produced in small quantities and be free of double images of common mirror surface graphics.

### FIELD OF THE INVENTION

This application is a Continuation in Part Application and claims priority to Provisional Patent No. 60/916,286 filed on May 5, 2007 and incorporated herein in its entirety by reference.

The disclosed system and method relate generally to graphic reproduction of images. More particularly, it relates to imparting indicia such as drawings, paintings, photos, signs, lettering and other decorative indicia, to a finished mirror in a method to provide a direct environmental reflection of the overlying graphic indicia thereby eliminating double imaging which has long been a vexing problem when graphic arts are combined with mirrored surfaces. Using a method of direct printing to a transparent interlayer as the carrier for indicia, the resulting device from the method herein yields high quality mirror products at low cost.

### BACKGROUND OF THE INVENTION

Placing indicia in the form of graphics, pictures, and text on mirrors has always been a very expensive procedure yielding less than satisfactory results. The process involves multiple printing for each color and registration of each printing pass. The process is extremely time consuming in that each color printed in each pass must be given time to dry before the next subsequent printing of a color or layer. Consequently, mirror-printed graphics are slow, very expensive to produce, and require large volumes of production for a profitable run given the time and labor intensive nature of the process. Further, this limits access of mirror-based imaging only to companies and buyers who can afford large volume orders and inhibits customization of one or a small number of mirrors by homeowners and small businesses with personal art or photos or advertising.

However, even when this tedious process for placing indicia on a mirrored surface is followed, the resulting product, almost always yields double images due to the reflection and refraction of the image through the glass, onto the mirrored surface, and back to the eye of the beholder. Consequently, the images and indicia are distorted to the viewer especially at increased angles of viewing from perpendicular to the finished mirror.

As such, there exists an unmet need for mirror production employing a graphics process which allows indicia in the form of high quality images and text on a background-mirrored surface, in an economical fashion. Such a process should yield a finished mirror with art, text, or other indicia upon it, which does not appear as double images to the viewing party. Further such a process should yield such high quality mirrored surface graphics using one or both of art or text-type graphics, in an economical and time conserving fashion. Additionally, such a process should be sufficiently economical to allow for single or small production runs such that they can be profitable. Finally, such a device and method should provide low cost and ease of production to allow homeowners and businesses to personalize mirrored surfaces with art, photos, or in the case of businesses, advertising customized to reflect business products and services to the viewer.

It is thus an object of this invention to provide a method of placement of indicia in the form of images and text and other art upon mirrored surfaces which yields a product that eliminates double images when viewed.

It is a further object of this invention to provide such a method and device which allows for economical production of one or a thousand mirrors with graphics upon them.

It is a further object of this invention to provide for placement of indicia on mirrors, which may be employed in an inexpensive large format or other digital printing using a direct application or lamination process.

It is yet another object of this invention to provide a method for rendering indicia and decorative graphics to a mirrored surface, which allows for imparting the indicia to a flexible interlayer easily printed at remote locations to the final mirror assembly.

With respect to the above description and background, before explaining at least one preferred embodiment of the invention in detail, it is to be understood that the invention is not limited in its application to the details of construction and to the arrangement of the components and/or steps set forth in the following description or illustrated in the drawings. The various apparatus and methods of the invention herein described and disclosed are capable of other embodiments and of being practiced and carried out in various ways which will be obvious to those skilled in the art once they review this disclosure. Also, it is to be understood that the phraseology and terminology employed herein are for the purpose of description and should not be regarded as limiting.

As such, those skilled in the art will appreciate that the conception upon which this disclosure is based may readily be utilized as a basis for the designing of other devices, methods and systems for carrying out the several purposes of the present disclosed device of graphic reproduction on mirrored surfaces with no double images in the final product. It is important, therefore, that the objects and claims be regarded as including such equivalent construction and methodology, insofar as they do not depart from the spirit and scope of the present invention.

### BRIEF DESCRIPTION OF DRAWINGS

FIG. 1 depicts a first mode of the device and method for digitally producing distortion free mirrors in a laminated process.

FIG. 2 shows a sliced view of the finished product of the method of FIG. 1.

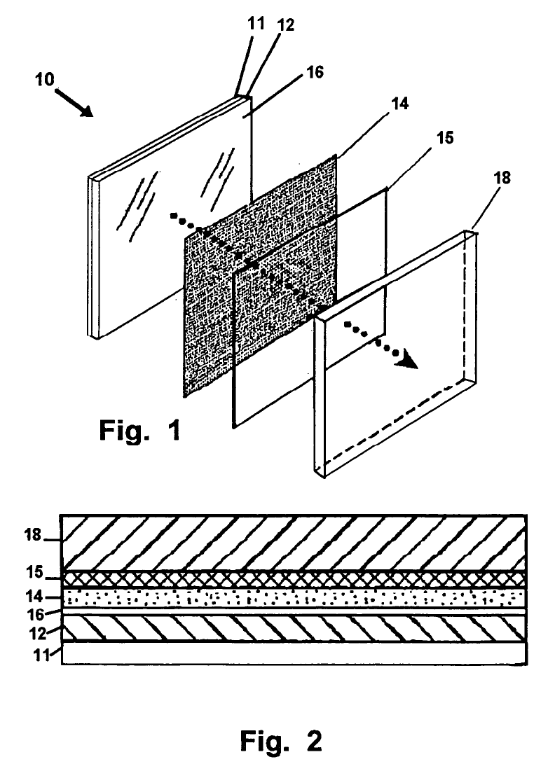

FIG. 1a is a second mode of the method herein.

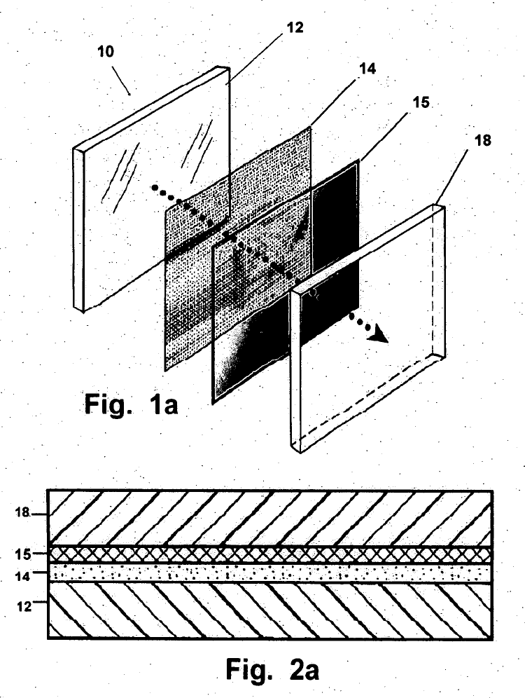

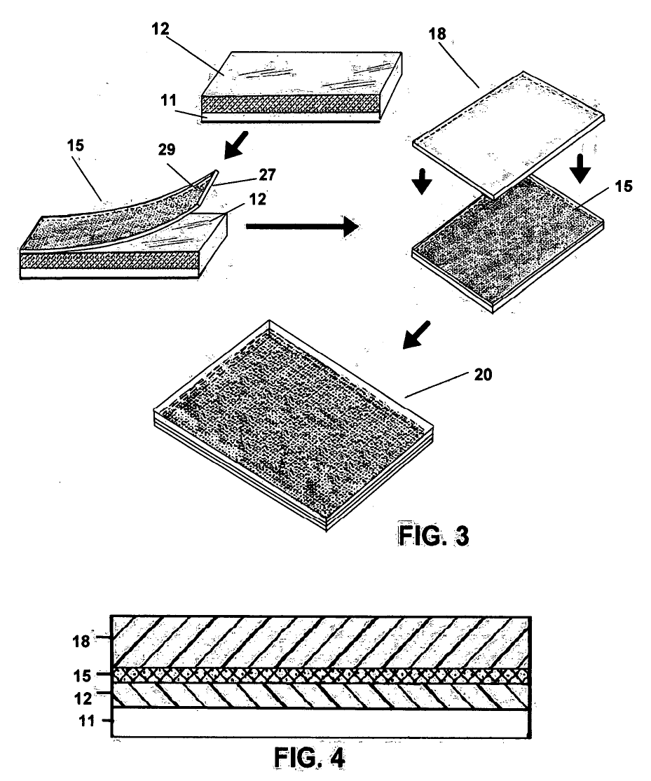

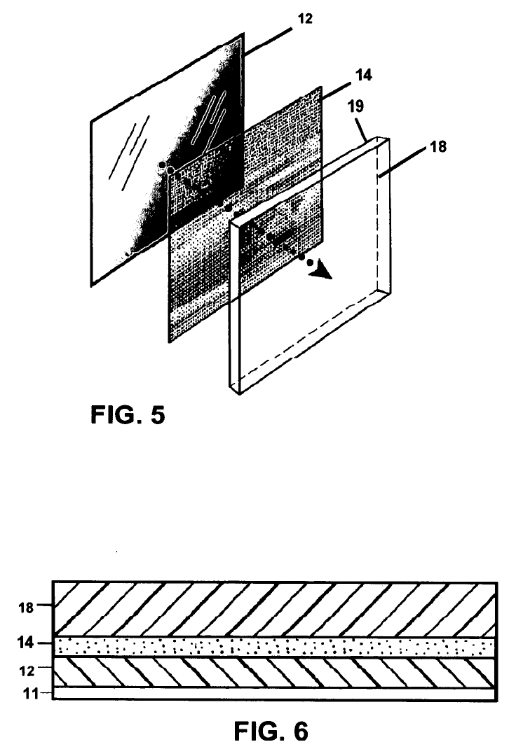

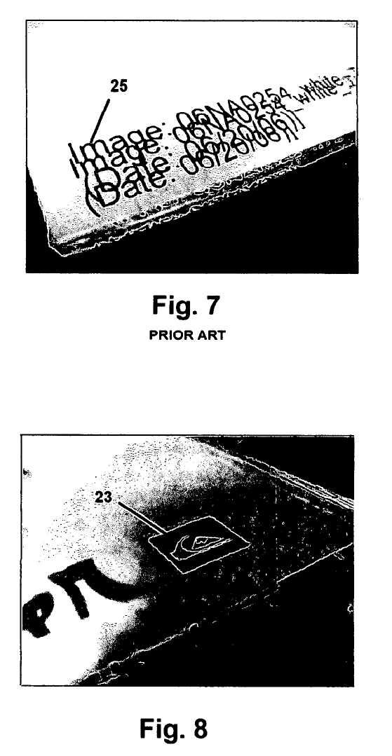

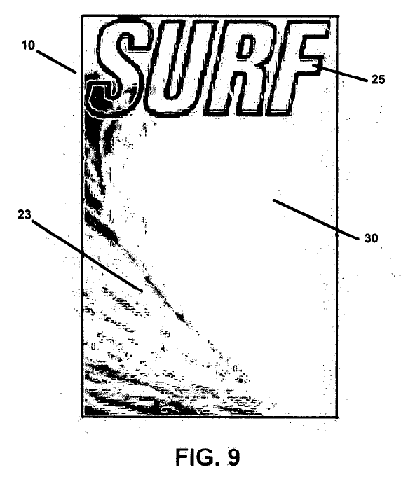

FIG. 2a is a sliced view of the finished laminate structure.

FIG. 3 is yet another mode of the method for producing a laminated mirror with distortion free graphics and indicia.

FIG. 4 depicts the product of the method of FIG. 3.

FIG. 5 depicts the method herein employed on a conventional silver nitrate type mirrored construction using the glass overlay as a carrier for indicia in reverse.

FIG. 6 depicts the product of the method of FIG. 5.

FIG. 7 depicts prior art mirrors with reflective distortion double imaging.

FIG. 8 shows a mirrored graphic in distortion free final form produced according to the method herein.

FIG. 9 depicts an embodiment of the device from the method herein yielding clean lettering and graphics for a realistic inclusion of the user's reflection in an open area.

### DESCRIPTION OF PREFERRED EMBODIMENTS OF THE INVENTION

Referring now to all of the drawings in FIGS. 1-9, wherein similar parts are identified by like reference numerals, there are shown embodiments of the device produced employing the variances on the method herein. Each device so produced yields high quality graphics on mirrored surfaces at low cost even in low volume and allows for digital imaging on such surfaces where heretofore silk screening or similarly expensive and time-consuming processes have been employed.

In the various modes of the method to yield the device, the graphics and indicia are produced by screen printing, or large or small format inkjet printing, or other means of digitally placing the graphics on a clear interface sheet, or directly upon the first surface mirror as the case may be. This allows for production of one mirrored surface with graphics at an inexpensive cost and short time, or thousands.

In a preferred mode of the invention, a composite mirror with overlain digitally produced graphics is formed by using a planar substrate 11 such as glass or other planar material on which is placed a highly reflective mirrored first-surface film to form a mirrored layer 12 which is adhered to the planar substrate surface 11. A thin substantially transparent protective coating 16 (as in FIG. 1) may be placed over the mirrored surface 12 layer on the glass generally of a few microns thickness and therefor generally providing no refractive aberrations. Thereafter the printed ink layer 14 forming indicia noted in FIG. 10, is positioned against the mirrored surface 12 or thin coating layer if employed. This ink layer 14 is formed preferably by employing digitally rendered artwork which is communicated from a wide format printer, or silk screened, onto a substantially transparent carrier, and then positioned immediately adjacent to the mirrored surface layer 12, or if employed, adjacent to the micron-thin protective coating 16.

In a further step of formation of the final mirror product, a means for adherence of overlying glass 18 and underlying ink layer 14 formed on a clear carrier material, and mirror 12, is employed currently in the form of a PVB interlayer 15 which serves to bond the stacked first four layers 11,12,16, and 14, with the sheet of glass 18. In a final step in the process, these stacked layers are heated to bond the layers together using the PVB interlayer 15 as the heat activated bonding means.

The result of the process and layering noted above yields substantially distortion-free indicia on a mirrored surface in any form which is printable such as lettering 25 or graphics 23 of photos or drawings and backed by the mirrored surface 12 as shown in FIGS. 8-9. Placing the indicia in the ink layer 14 on, against, or substantially adjacent to the mirrored surface 12 thus eliminates the prior noted aberration and double image problems of conventional mirrored printing shown in FIG. 7.

In one preferred mode of the device and method as shown in FIG. 1a and FIG. 2a the mirrored surface 12 layer is preengaged upon the planar surface 11 such as glass or other stiff planar surface adapted for adherence of the mirrored surface 12. Then, directly upon the exposed mirrored surface 12 layer, using a wide format inkjet style printer with appropriate ink, the indicia is applied directly on the mirrored surface 12 in the second step depicted as ink layer 14 in the figures. Since ink layers 14 and printed inks are generally applied in very small dots known as halftoning in such printing, there are also areas of exposed mirrored surface 12 surrounding the microdots of the thin ink layer 14 forming the indicia such as lettering 25 or graphics 23.

Thereafter a clear PVB polyvinyl butyral interlayer is placed upon the printed surface of the first surface mirror 12 and sandwiched in-between a sheet of glass 18. Thereafter the stacked layers are subjected to a heating process which bonds the layers into a unitary structure with the PVB layer adhering the glass 18 to the exposed areas around halftoning on the first surface mirror 12 and to the ink layer 14. The result is a finished mirror as in FIG. 9 which when viewed by a user provides distortion free graphics 23 and lettering 25 and any other indicia placed thereon to the viewing user, with the user in the picture.

This is a vast improvement over conventional mirrored graphics 23 and other types of indicia which when applied to the glass 18 as conventionally produced and shown in FIG. 7 produces double images especially at increasing viewing angles from a perpendicular viewpoint.

In another particularly preferred version of the device and method herein depicted in FIG. 3 and 4, a finished mirror is formed using the mirrored surface 12 layer engaged to the substrate 11 using indicia such as a photograph or other types of graphics 23 or lettering. This embodiment of the device and method are particularly preferred because the indicia displayed on the final formed mirror 20, rather than being engaged with the mirrored surface 12 or a protective layer, is instead engaged directly on a first surface 27 of a substantially transparent interlayer which is thereafter mated with the mirrored surface 12. Indicia using this mode of the device and method, is printed or silkscreened or otherwise placed on a first surface 27 a substantially transparent interlayer such as a PVB interlayer 15. This mode of the device is especially well adapted to produce high quality mirrors with distortion free indicia, in very low numbers, and can do so at a cost, in time and money, far lower than conventional methods. By employing a transparent interlayer such as the PVB interlayer 15 as the carrier for the ink forming the ink layer forming the chosen indicia, easy reproduction of high quality graphics 23, lettering 25 or any other type of indicia is afforded by using wide format printers such as inkjet printers.

Since only the lightweight transparent interlayer shown as the flexible PVB interlayer 15 need be moved about in the printing process, much like a sheet of printing paper, high quality indicia can be printed or otherwise imparted onto the PVB layer 15 at a remote site from where the mirror 20 will be assembled. Photographic stores, or poster stores, online sites, or other venues capable of taking indicia in digital format and printing it on a transparent interlayer such as a PVB interlayer 15, will be able to receive a customer's artwork and place it for inclusion into the final mirror 20 which is assembled elsewhere. In fact, a transparent interlayer material might be provided to users with their own printer and computer allowing them to print their desired indicia on the interlayer and send it to an assembly plant for inclusion in the formed mirror 20.

By using the PVB interlayer 15 as the carrier for the ink layer 14 forming the indicia making up the artwork, it allows for a single high quality mirror with custom indicia thereon to be produced, which does not have double images once finished. Time for production which presently involves multiple passes of silkscreening, drying time, multiple screens for color separation, and resulting costs are reduced by a major factor since inkjet printing allows for full color renditions of the indicia to be placed on PVB layer 15 or other adhereable transparent interlayer.

The indicia if in color is fully registered without the need for multiple passes of silkscreens and drying of different ink layers. Further, no large scale manufacturing plant is required for graphic reproductions as would be the case with heavy mirrors and silkscreening.

In this particularly preferred mode of the device and method herein, to eliminate the double imaging and allow for the interlayer or PVB interlayer 15 to be the carrier for the ink layer 14, the indicia is printed in reverse, on a first side 27 of the transparent interlayer such as the PVB interlayer 15. This first side 27 is then directly engaged with the mirrored surface 12 during the curing or adherence process, forming the final mirror 20. Placing the indicia in reverse on the first side 27 positions the ink layer 14 sufficiently adjacent to the mirrored surface 12, to substantially eliminate any distortion caused by refraction through even the transparent interlayer formed by the PVB interlayer 15.

By printing in reverse the back side of ink layer 14 is visible through the transparent interlayer thereby giving the viewer a normal image view. This printing on the back side, closest to the reflective surface or touching it, also serves as noted, to place the ink layer 14, as close as possible to the reflective surface to eliminate any chance of abberations in the reflection.

In a final step, the glass 18 is placed upon the second surface 29 of the interlayer and the mirrored surface 12 and the glass 18 are adhered to the transparent interlayer which as shown is a PVB interlayer 15 and under heat provides the means of adherence of the mirrored surface 12 to the glass 18 with the ink layer 14 sandwiched therebetween. Of course those skilled in the art, will realize that other interlayer materials might be employed other than a PVB interlayer 15 so long as they are substantially transparent, adapted for adherence of the ink layer 14 and capable of adherence in-between the first surface mirror 12 and the overlayed glass 18.

While the PVB interlayer 15 is currently preferred since it is adapted to carry the ink layer 14 and is heat curable to provide the means of engagement of the glass 18 to the ink layer 14 and surrounding mirror surface 12, such engagement might be achieved using a clear adhesive between a clear interlayer material and both the glass 18 and the first surface mirror 12. Or, it may be accomplished in other manners where the interlayer bearing the indicia is sandwiched in position between the glass 18 and against the mirrored surface 12. Or, the clear interlayer might be held in this sandwiched position by biasing the glass 18 and first surface mirror 12 toward each other using a frame or other means to hold the layers with their respective surfaces tightly in contact across substantially all of their respective surfaces.

However, currently the PVB interlayer 15 provides excellent results and is easily printed upon with conventional inkjet style printing for deposit of the ink layer 14.

Additionally, while printing in reverse or backwards on the first surface 27 of the transparent interlayer material is the most preferred mode of the device and method because it places the indicia directly in contact with the mirrored surface 12 and eliminates refractive distortion, if a lesser quality but still-improved mirror is acceptable, printing on the second surface 29 of the interlayer material in a normal fashion could be done.

In this mode the resulting mirror, while a vast improvement over conventional mirrored graphics, would suffer a very slight distortion from the refraction through the interlayer which would appear in the final product.

All these variations are anticipated within the scope of this patent since substantial utility is yielded by the disclosed method herein of employing a substantially transparent and very thin interlayer as the carrier for the ink layer 14 forming the indicia. Using the interlayer as the carrier as noted allows the indicia to be imparted using computers directly communicating digitized indicia to an inkjet or similar large format printer or electronic silkscreening process. The result being that as little as one, or many thousands of such assembled mirrors 20 can be produced quickly, economically, with the finally assembled mirror having substantially no visual distortion of the indicia when viewed by a user. The disclosed method and device thus allow for the use of the final mirror 20 as a display surface for family photos, advertisements, pictures, or virtually any graphic image that can be imparted to the ink layer 14.

FIG. 9 depicts a particularly preferred mode of the device and method herein wherein a distortion free mirror is formed in a manner to put the viewer, into the graphic depiction formed by the ink layer 14. As can be seen, the indicia has graphics 23 and lettering 25 combining to depict a magazine cover. An open reflective area 30 is positioned to place the viewer's reflection into the depiction. Since the mirror 20 is formed using one of the aforementioned modes, such as that noted above in FIG. 3, there is no aberration from refraction of the indicia through the glass 18. The depiction can be made to seem extremely real to the viewer by the placement of the indicia 14 on the first surface of the interlayer material and the reflective area 30 very accurately positioned to place the viewer's reflection in the appropriate position to become part of the depiction. The result is a highly accurate rendering to the viewer of themselves in a graphic depiction formed by the indicia with no double images or aberration to impair the viewing pleasure or realism of the scene communicated to the viewer.

This method of forming the device herein if the glass 18 is engaged by a frame to the mirrored surface 12, would allow for changing of the graphic depiction of the indicia by removing the glass and changing the interlayer material acting as the ink layer 14 carrier forming the indicia. As seasons or sponsors change, the graphic image provided by the ink layer 14 may also be changed. Or, the finished mirrors can also be formed in the permanent fashion using the PVB layer or other means for permanently adhering substantially all of the glass surface against the ink layer of the interlayer which is against substantially all of the surface area of the mirror surface 12.

A final mode of the device and method herein, is depicted in FIGS. 5-6. This mode employs the mirror surface 12 layer affixed upon an underlying planar substrate such as glass in a conventional process using silver nitrate solution. In a next step, using ink dispensed from a wide format printer, or other means for digital reproduction of artwork and indica, the indicia forming the ink layer 14 is applied as shown in FIG. 6 to the interior surface 19 of the glass 18 and printed backwards or in reverse when viewed from the interior surface 19 side thus making the indicia appear correctly from the opposite surface of the glass 18. Thereafter the glass 18 is mated against the formed first surface mirror 12 and a distortion free mirror is produced.

This mode while simpler than the aforementioned modes, does require movement and transport of the large mirrored surfaces 12 and rigid substrates to the large format printers and not as easily carried out as the aforementioned employment of an interlayer directly on the first surface mirror 12 and one side of the glass 18 overlay. While still yielding final mirror products which are substantially distortion free since the indicia is not refracted by a thickness of glass or plastic, this mode of the method and device would not provide the ease of use and utility of placing the indicia on the transparent interlayer and is thus somewhat less useful.

As noted, the methods herein are particularly well employed to produce high quality distortion free indicia such as graphic images or lettering on mirrored surfaces. It is to be understood, however, that elements of different construction and configuration and different steps and process procedures and other arrangements thereof, other than those illustrated and described, may be employed for providing the apparatus and any method herein withing the spirit of this invention.

As such, while the present invention has been described herein with reference to particular embodiments thereof, a latitude of modifications, various changes and substitutions are intended in the foregoing disclosure, and it will be appreciated that in some instance some features of the invention could be employed without a corresponding use of other features without departing from the scope of the invention as set forth in the following claims. All such changes, alternations and modifications as would occur to those skilled in the art are considered to be within the scope of this invention as broadly defined in the appended claims.

What is claimed is:

1. A mirror reflecting substantially distortion free indicia thereon comprising:
a planar surface having a reflective surface;
an interface sheet having a first side for placement against said reflective surface, and a second side opposite said first side;
indicia positioned on one of said first and second sides of said interface sheet;
a substantially transparent cover sheet;
means for engagement of said cover sheet to said interface sheet, whereby said indicia is positioning on said interface sheet adjacent to said reflective surface, yields a substantially distortion free reflection of said indica in said reflective surface.

2. The mirror having substantially distortion free indicia thereon of claim 1, further comprising:
said indicia positioned upon said first side of said interface sheet;
said indicia printed backwards; and
whereby said indicia is substantially in contact with said mirrored surface and said indicia appears correctly to the eye of a viewer viewing said indicia.

3. The mirror having substantially distortion free indicia thereon of claim 2, further comprising:
a protective coating of substantially transparent material covering said reflective layer;
said coating having a thickness substantially thin to prevent distortion of said indicia when reflecting in said reflective surface.

4. A method of manufacturing the mirror of claim 1, comprising: thereon comprising:
placing a reflective surface film upon a planar surface;
positioning indicia upon a printing surface of a substantially transparent interface sheet;
positioning said interface sheet with said printing surface adjacent to said reflective surface; and
employing means to engage said planar surface and said interface sheet in an engagement to each other, whereby said indicia is reflected in said reflective surface upon viewing by a viewer.

5. The method of manufacturing the mirror of claim 4, further comprising the steps of:
positioning said indicia backwards upon said printing surface of said interface sheet, whereby said indicia, when reflected in said reflective surface, appears correctly to the eye of a viewer.

6. The method of manufacturing the mirror of claim 4, further comprising the steps of:
employing a planar sheet of of substantially transparent adhesive material as an interlayer between a clear plastic or glass covering for said interface sheet.

7. The method of manufacturing the mirror of claim 5, further comprising the steps of:
employing a planar sheet of substantially transparent adhesive material as an interlayer between a clear plastic or glass covering for said interface sheet.

8. The method of manufacturing the mirror of claim 6, further comprising the steps of:
employing a said interface sheet as said interlayer between a clear plastic or glass covering for said interface, whereby said indicia can be printed on said interlayer which is then employed to adhere said covering.

9. The method of manufacturing the mirror of claim 7, further comprising the steps of:
employing a said interface sheet as said interlayer between a clear plastic or glass covering for said interface, whereby said indicia can be printed on said interlayer which is then employed to adhere said covering.

10. The method of manufacturing the mirror of claim 6, further comprising the steps of:
digitizing a photograph or graphics to form an image; and
employing an inkjet printer to place said image on said printing surface of said interface, whereby photographs can be given a mirrored background.

11. The method of manufacturing the mirror of claim 7, further comprising the steps of:
digitizing a photograph or graphics to form an image; and
employing an inkjet printer to place said image on said printing surface of said interface, whereby photographs can be given a mirrored background.

12. The method of manufacturing the mirror of claim 6, further comprising the steps of:
employing a planar sheet of polyvinyl butyral for said interlayer.

13. The method of manufacturing the mirror of claim 7, further comprising the steps of:
employing a planar sheet of polyvinyl butyral for said interlayer.

14. The method of manufacturing the mirror of claim 8, further comprising the steps of:
employing a planar sheet of polyvinyl butyral for said interlayer.

15. The method of manufacturing the mirror of claim 9, further comprising the steps of:
employing a planar sheet of polyvinyl butyral for said interlayer.

16. The method of manufacturing the mirror of claim 10, further comprising the steps of:
employing a planar sheet of polyvinyl butyral for said interlayer.

17. The method of manufacturing the mirror of claim 11, further comprising the steps of:
employing a planar sheet of polyvinyl butyral for said interlayer.
